(19) United States
(12) Patent Application Publication
(10) Pub. No.: US 2024/0169363 A1
(43) Pub. Date: May 23, 2024

(54) Proof of Ownership of Extended Reality Objects

(71) Applicant: AT&T Intellectual Property I, L.P., Atlanta, GA (US)

(72) Inventors: Wei Wang, Harrison, NJ (US); Mikhail Istomin, Brooklyn, NY (US); Lars Johnson, Brooklyn, NY (US); Rachel Rosencrantz, Seattle, WA (US)

(73) Assignee: AT&T Intellectual Property I, L.P., Atlanta, GA (US)

(21) Appl. No.: 17/993,636

(22) Filed: Nov. 23, 2022

(51) Int. Cl. G06Q 30/00; G06T 19/00

(52) U.S. Cl. CPC G06Q 30/018; G06T 19/00

(57) ABSTRACT

An extended reality (“XR”) server computer can identify a plurality of XR objects present in an XR environment. The XR server computer can determine an owner for an XR object of the plurality of XR objects. The XR server computer can visually differentiate, based on the owner, the extended reality object from other extended reality objects of the plurality of extended reality objects. The XR environment can be a virtual reality (“VR”) environment, an augmented reality (“AR”) environment, or a mixed reality environment. The XR server computer can create an ownership chain for the owner. The XR server computer can assign the XR object and at least one additional XR object to the ownership chain. The XR server computer can receive a request to transfer ownership of the XR object and can commit the transfer from a source ownership chain to a destination ownership chain.

### BACKGROUND

The advent of metaverse as a potential successor to the Internet will bring a number of changes. One foreseeable change is the way in which people interact with non-physical environments. Today, interactions with the Internet are limited to text and multimedia consumption (known as web2—read and write). This media is usually static in nature, such as webpages with multimedia (e.g., images, audio, and/or video). More dynamic interactions are either limited (e.g., forums, chat rooms, social media groups, and the like) or handled in a strictly-controlled environment (e.g., voice, video, and/or text chat and multiplayer games). Metaverse (also known as web3—read, write, own) is likely to bring changes to interactions, allowing for more interactive environments (e.g., virtual rooms) to be accessed with more of a free flow approach. For example, a user can setup virtual rooms and environments in the same way that a user can setup a web site today. The difference, however, is how much flexibility there will be in a space that the user does not own.

The freedom and easy access to create and change virtual environments at-will can also create a number of issues. In terms of security, a guest cannot easily determine who owns what virtual object and cannot easily identify any security measures in place within the environment to ensure no malicious objects are present. Current web browsers provide a lock icon next to the uniform resource locator (“URL) to indicate that the associated web page is encrypted and that a secure connection to the web page has been made ensuring that all the elements of the web page (e.g., text, images, video, and the like) are coming from known sources. This functionality is further enforced by browsers implementing prevention of mixed/insecure content inside of a secure web page.

On the other hand, a metaverse environment might not be a monolithic entity. A single virtual room might contain multiple objects, and some of the objects might not be part of the original environment. For example, other users' avatars or objects left by other users (if allowed to; similar to a forum post), would not be directly owned/belong to the environment. As such, identifying whether the environment is safe and secure becomes more complex problem. The ability to identify, at a glance, the security of a virtual environment is vital.

### SUMMARY

Concepts and technologies disclosed are directed to proof of ownership of virtual objects. More particularly, the concepts and technologies disclosed herein provide the ability to identify, at a glance, the security of an extended reality (“XR”) environment. One way to achieve this is to identify ownership of each XR object in the XR environment and use that ownership information to evaluate the trustworthiness of each XR object.

According to one aspect of the concepts and technologies disclosed herein, an XR server computer can identify a plurality of XR objects present in an XR environment. The XR server computer can determine an owner for an XR object of the plurality of XR objects. The XR server computer makes this determination based upon XR object ownership data associated with the XR object. In some embodiments, the XR object ownership data can include one or more authentication credentials that uniquely identified the owner. The XR server computer can visually differentiate, based on the owner, the extended reality object from other extended reality objects of the plurality of extended reality objects. The XR environment can be a virtual reality (“VR”) environment, an augmented reality (“AR”) environment, or a mixed reality environment.

In some embodiments, the XR server computer can create an ownership chain for the owner. The XR server computer can assign the XR object and at least one additional XR object to the ownership chain. The XR server computer can receive a request to transfer ownership of the XR object and can commit the transfer from a source ownership chain to a destination ownership chain.

In some embodiments, the XR server computer can receive a request to transfer ownership of the XR object. The XR server computer can determine a source ownership chain and a destination ownership chain. The XR server computer can commit a transfer of ownership of the XR object from the source ownership chain to the destination ownership chain. The ownership chain for the owner can be the source ownership chain. The ownership chain for the owner can be the destination ownership chain.

In some embodiments, the XR server computer can determine whether any of the plurality of XR objects are unassigned. In response to determining that at least one of the plurality of extended reality objects is an unassigned extended reality object, the XR server computer can remove the unassigned XR object from the XR environment.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a block diagram illustrating aspects of an illustrative operating environment in which the concepts and technologies disclosed herein can be implemented.

FIG. 1B is a block diagram illustrating an example extended reality (“XR”) environment, according to an illustrative embodiment.

FIG. 2 is a flow diagram illustrating aspects of a method for determining ownership of XR objects within an XR environment, according to an illustrative embodiment.

FIG. 3 is a flow diagram illustrating aspects of a method for transferring ownership of XR objects, according to an illustrative embodiment.

FIG. 4 is a flow diagram illustrating aspects of a method for identifying unverified XR objects within an XR environment, according to an illustrative embodiment.

FIG. 5 is a block diagram illustrating an example computer system capable of implementing aspects of the embodiments presented herein.

FIG. 6 schematically illustrates a network, according to an illustrative embodiment.

FIG. 7 is a block diagram illustrating an example mobile device and components thereof, according to an illustrative embodiment.

### DETAILED DESCRIPTION

The concepts and technologies disclosed herein enable the assignment of provable ownership to each and every object inside a XR environment. This can be implemented in such a way that ownership can be visually identified and traced to the original owner. This will provide two benefits. First, this will allow for the identification of the items that do not belong in the XR environment and that might pose a security risk. Second, this would allow for propagation of trust from owner to the object.

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer system, including hand-held devices, mobile devices, wireless devices, multiprocessor systems, distributed computing systems, microprocessor-based or programmable consumer electronics, minicomputers, mainframe computers, routers, switches, other computing devices described herein, and the like.

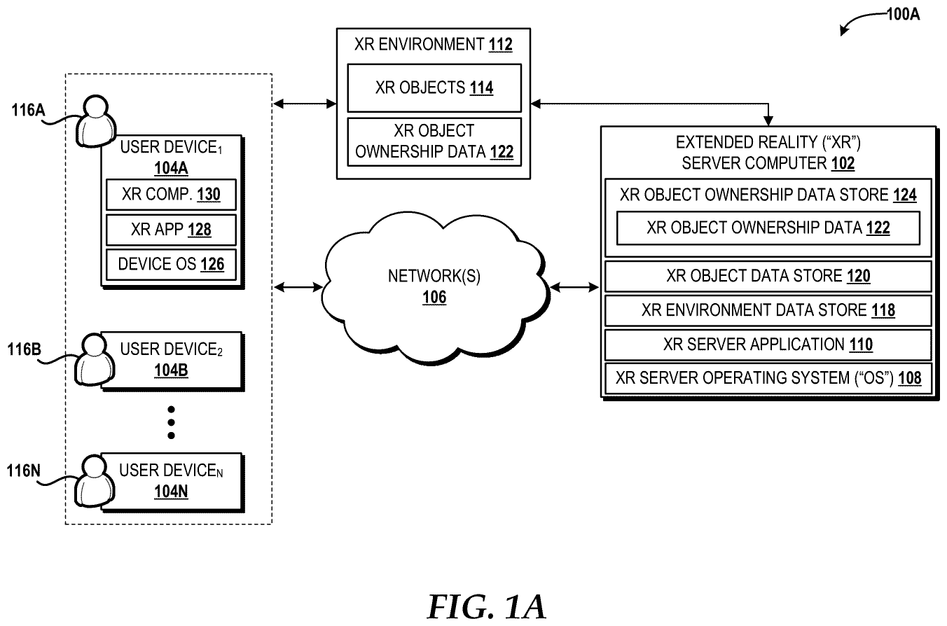

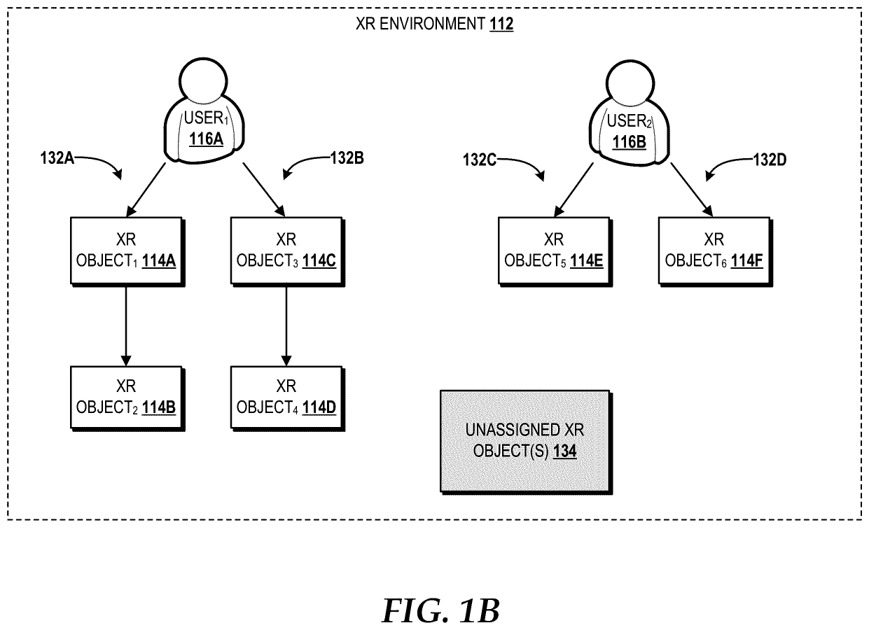

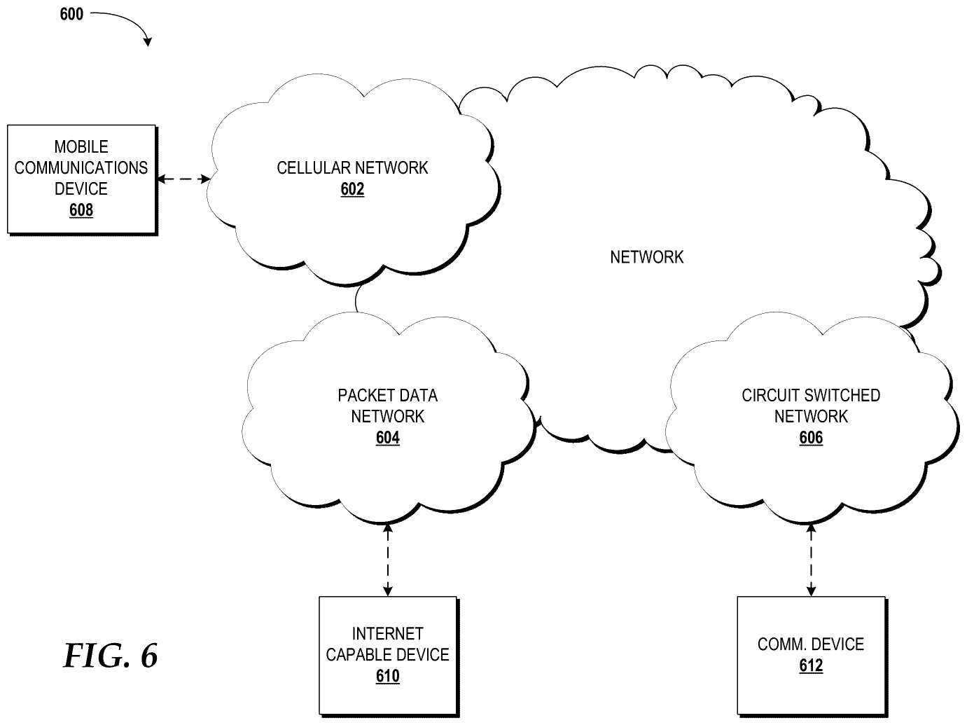

Referring now to FIG. 1A, aspects of an operating environment 100A in which various embodiments presented herein may be implemented will be described, according to an illustrative embodiment. The illustrated operating environment 100A includes an extended reality (“XR”) server computer 102. The XR server computer 102 can provide an XR service to a plurality of user devices 104A-104N (hereafter referred to collectively as “user devices 104” or individually as “user device 104”). The XR service can be a virtual reality (“VR”) service, an augmented reality (“AR”) service, a mixed reality service, or any combination thereof. The XR server computer 102 and the user devices 104 can communicate via one or more networks 106, such as described in greater detail below with reference to FIG. 6.

The XR server computer 102 can execute an XR server operating system (“OS”) 108 and one or more application programs such as an XR server application 110. The XR server OS 108 is a computer program for controlling the operation of the XR server computer 102. The XR server application 110 is an executable program configured to execute on top of the XR server OS 108 to provide various functions described herein.

The XR server computer 102 can provide, at least in part, via execution of the XR server application 110, a VR service to the user devices 104. “Virtual reality” or “VR” is used herein to describe a concept that provides a computer-generated environment (also referred to herein as a “virtual” environment”) that a user can explore via a device, such as the user device 104. A virtual environment can include a gathering of many individual objects that represent small parts of the overall environment. A virtual environment may be a single room, a house, a city, a world, or any other virtualization of a real-world environment. The virtual environment may be a completely imaginary environment that does not have a real-world analog. The virtual environment may be a combination of real-world and imaginary environments. A virtual object can represent any real-world object, such as furniture, individual avatars (i.e., representations of real-world users), animals (e.g., virtual pets and wildlife), vehicles, electronics, and the like. Each virtual object may belong to a virtual environment. A virtual object may be something that was created as part of the virtual environment. Alternatively, a virtual object may be something that was added at a later point by either the environment owner or another user.

A VR environment can be generated by any software framework designed for the creation and development of graphics. Some example software frameworks include, but are not limited to, UNREAL ENGINE (available from Epic Games), UNITY (available from Unity Technologies), CRYENGINE (available from Crytek), HAVOK VISION ENGINE (available from Havok), and open source software frameworks. In some embodiments, the software frameworks utilize graphics assets, such as textures, that include or are derived from photographs of the real-world environment that is to be virtualized. Those skilled in the art will appreciate the wide range of graphical fidelity, visual styles, and other attributes a particular VR environment may have, and as such, further details in this regard are not provided herein.

The XR server application 110 can provide, at least in part, via execution of the XR server application 110, an AR service to the user devices 104. “Augmented reality” or “AR” is used herein to describe a concept in which at least a portion of a physical, real-world environment is augmented to include computer-generated data. The computer-generated data can include virtual objects that are presented over and/or spatially integrated with real-world objects of the physical, real-world environment. The virtual objects can include text, colors, patterns, gradients, graphics, other images, videos, animations, combinations thereof, and the like. Computer-generated data that augments in some manner a view of a physical, real-world environment and/or elements thereof is referred to herein generally as an “augmentation.”

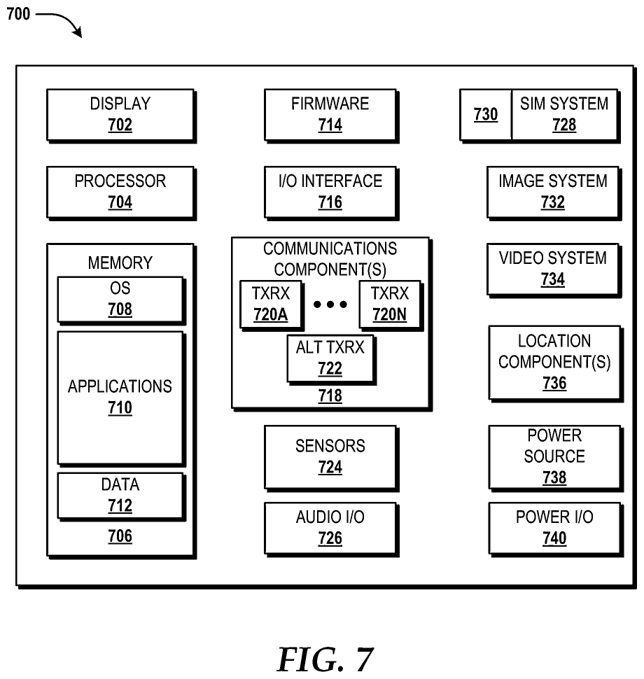

The AR service can provide a live view of a physical, real-world environment. In these embodiments, the AR service may utilize a camera component (best shown in FIG. 7) of the user device 104 to provide a live view of the physical, real-world environment to be augmented. In other embodiments, the AR service can provide a non-live view of a physical, real-world environment. In these embodiments, the non-live view can present a physical, real-world environment as a static image. Accordingly, a reality that is to be augmented need not be a present reality and can instead be a past reality, encapsulated in a photograph that is augmented at a later time such as the present, for example.

The XR server application 110 can provide, at least in part, via execution of the XR server application 110, a mixed reality service to the user devices 104. “Mixed reality” is used herein to describe a concept in which elements of VR and elements of AR are used together.

In the illustrated example, the XR server computer 102 provides an XR environment 112, which can be a VR environment, an AR environment, or a mixed reality environment. The XR environment 112 can contain any number of XR objects 114. The XR objects 114 can be owned by one or more users 116A-116N who are associated with the user devices 104A-104N, respectively. The XR objects 114 alternatively may be owned by the XR environment 112 itself or the host thereof (e.g., the XR server computer 102). The XR server computer 102 can store the XR environment 112 and all related data in an XR environment data store 118. Although the XR environment data store 118 is shown as part of the XR server computer 102, the XR environment data store 118 may be external to the XR server computer 102 and accessible locally via a direct connection or remotely over the network(s) 106. The XR server computer 102 also can store the XR objects 114 and identifying data in an XR object data store 120. Although the XR object data store 120 is shown as part of the XR server computer 102, the XR environment data store 120 may be external to the XR server computer 102 and accessible locally via a direct connection or remotely over the network(s) 106. The XR server computer 102 can also store XR object ownership data 122 in an XR object ownership data store 124. The XR object ownership data 122 can identify the owner, such as one of the users 116, of each XR object 114 in the XR environment 112. The XR object ownership data 122 can include a username or a real name of each of the users 116 and one or more XR object IDs that each uniquely identify the XR object(s) 114 that each of the users 116 owns. Additional credentials such as a password, multi-factor authentication, or the like may be used to establish the identity of the users 116 and to prevent spoofing. In some embodiments, the users 116 must create a user profile that includes biographical data, physical address data, web reputation data, social media data, and/or other data that is representative of the users' 116 online presence to enhance a determination of trustworthiness of the users 116.

The illustrated user devices 104 can be or can include one or more mobile telephones, smartphones, tablet computers, slate computers, smart watches, fitness devices, smart glasses (e.g., the GOOGLE GLASS family of products), a dedicated AR device, a dedicated VR device, a dedicated mixed reality device, a wearable device, mobile media playback devices, laptop computers, notebook computers, ultrabook computers, netbook computers, computers of other form factors, computing devices of other form factors, other computing systems, other computing devices, and/or the like. It should be understood that the functionality of the user devices 104 can be provided by a single device, by two or more similar devices, and/or by two or more dissimilar devices. For purposes of describing the concepts and technologies disclosed herein, the user devices 104 is described herein as a smartphone. It should be understood that this embodiment is illustrative, and should not be construed as being limiting in any way.

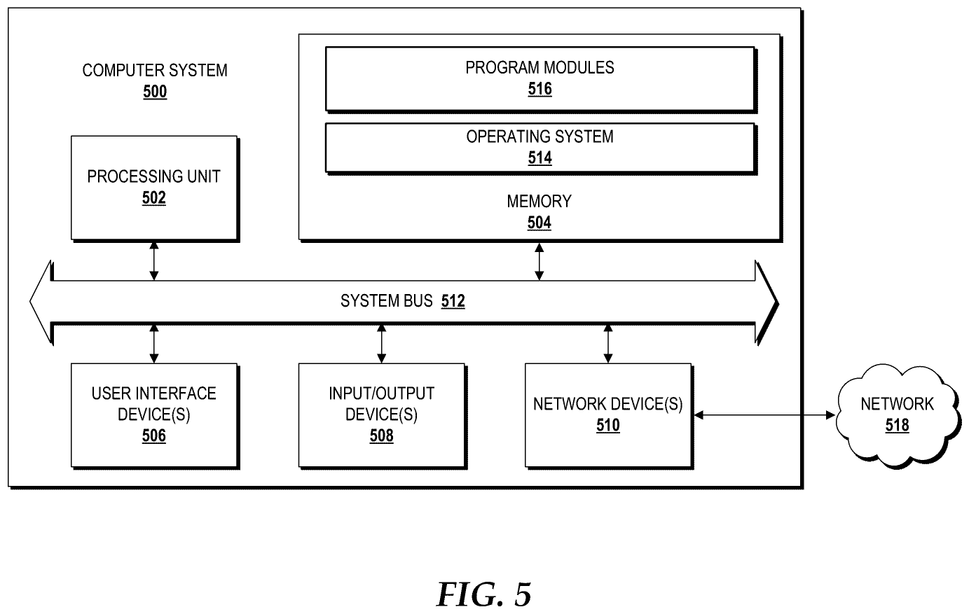

In the illustrated example, a first user device 104A includes a device OS 126, an XR app 128, and an XR component 130. The other user devices 104B-104N can be configured the same as or similar to the first user device 104A. It should be understood, however, that the user devices 104 can include other components. Illustrative example architectures of the user devices 104 are described in greater detail herein with reference to FIGS. 5 and 7.

The device OS 126 can control the operation of the user device 104. In some embodiments, the device OS 126 includes the functionality of the XR app 128. The device OS 126 can be executed by one or more processors (best shown in FIGS. 5 and 7) to cause the user device 104 to perform various operations. The device OS 126 can include a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The XR app 128 can execute on top of the device OS 126. The XR app 128 can be executed by one or more processors (best shown in FIGS. 5 and 7) to cause the user device 104 to perform various operations described herein. The XR app 128 can be a client-side application that communicates, via the network(s) 106, with the XR server application 110 executing on the XR server computer 102 to provide, at least in part, an XR service to the user 116 of the user device 104. The XR app 128, in some embodiments, can utilize the XR component 130 to provide, at least in part, an XR service to the user 116 of the user device 104. The illustrated embodiment of the XR component 130 represents the XR component 130 as an internal component of the user device 104. It should be understood that the XR component 130 alternatively may be an external component that is in communication with the user device 104 via a wired or wireless connection. The XR component 130, in some embodiments, is or includes a camera (e.g., a still camera and/or video camera), a sensor (e.g., an accelerometer, a global positioning system sensor, a solid state compass, or the like), a display (e.g., an integrated display, a head-mounted display, an eyeglasses display, a head-up display, an external monitor, a projection system, or a holographic display), an input device, or the like. The XR component 130, in other embodiments, is or includes a display (e.g., an integrated display, a head-mounted display, an eyeglasses display, a head-up display, an external monitor, a projection system, or a holographic display), an input device, a combination thereof, or the like. In some embodiments, the XR component 130 is META QUEST (available from META), PLAYSTATION VR (available from SONY), HTC VIVE (available from HTC and VALVE), MICROSOFT HOLOLENS (available from MICROSOFT), or the like. The XR app 128 can provide an interface, using the XR component 130, through which the user 116 can interact with the XR environment 112 provided, at least in part, by the XR server computer 102.

Turning now to FIG. 1B, an example XR environment 112 will be described, according to an illustrative embodiment. The XR environment 112 can be generated, at least in part, by the XR server computer 102. The XR server computer 102 can provide the XR environment 112 to the XR app 128 executing on the user device 104. The XR app 128 can present the XR environment 112 to the user 116 via the AR component 130. In real-world implementations, each of the user devices 104 can interact with the XR server computer 102 in a similar manner. In some embodiments, one of the user devices 104 can provide the functionality of the XR server computer 102. In these embodiments, the XR environment data store 118 and the XR object data store 120 may be hosted locally on the user device 104 or accessible remotely via the network(s) 106. The XR object ownership data store 124 can be maintained separately by a third party entity (i.e., other than the users 116) to ensure that integrity of the data is maintained.

In the illustrated example, the first user 116A and the second user 116B are each shown as being the owner of multiple XR objects 114. The first user 116A is shown as the owner of XR objects 114A-114D. The second user 116B is shown as the owner of XR objects 114E-114F. Moreover, each of the XR objects 114 belongs to an ownership chain 132. In particular, the XR objects₁₋₂ 114A-114B belong to a first ownership chain 132A, the XR objects₃₋₄ 114C-114D belong to a second ownership chain 132B, the XR objects 114E belongs to a third ownership chain 132C, and the XR object₆ 114F belongs to a fourth ownership chain 132D.

The ownership chains 132 simplify the process of trust propagation. For example, if the first user 116A owns the XR environment 112 (e.g., a virtual room) and also owns all of the XR objects 114 within that virtual room (e.g., all the virtual furniture in the room), then ownership would be assigned to the room and so forth. This would create a number of ownership chains 132 (e.g., Room Owner=>Room=>Room's Table=>Table's Chairs). When setup in such a way, only the top object/owner would need to be verified and authenticated, allowing all sub-objects to be on the same trust level as the root owner. One way to implement this is to setup a blockchain-like system starting at the owner root and branching into each individual XR object 114. Once implemented, every XR object 114 in the XR environment 112 should be identifiable by its root owner (i.e., the first user 116A in this example).

As a side benefit of this implementation, the transfer of ownership can be achieved simply by moving an XR object 114 from one ownership chain 132 to another. Another benefit is that no matter what XR object 114 is chosen as the starting point, it is possible to go up the ownership chain 132 to identify the root owner of that XR object 114 and the ownership chain 132 as a whole. Using this implementation, all of the XR objects 114 within the XR environment 112 can be marked, highlighted, or otherwise visually identified as being owned by one of the users 116. By this same process, any object in the XR environment 112 that either does not have an owner present (i.e., engaged currently in the XR environment 112; in person or via an avatar) or does not belong (i.e., a potential malicious object that contains a virus of other malicious code) can be easily identified and removed. In the illustrated example, unwanted, suspicious, or otherwise unassigned XR objects 134 are shown without a present, corresponding owner.

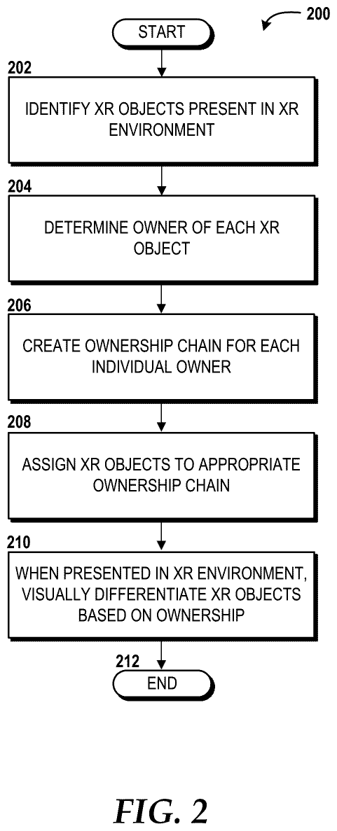

Turning now to FIG. 2, aspects of a method 200 for determining ownership of the XR objects 114 within an XR environment 112 will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in their respective entireties. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including the XR server computer 102, the user device 104, single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof refers to causing a processor of a computing system or device, such as the XR server computer 102, the user device 104, to perform one or more operations and/or causing the processor to direct other components of the computing system or device to perform one or more of the operations.

For purposes of illustrating and describing some of the concepts of the present disclosure, the methods disclosed herein are described as being performed, at least in part, the XR server computer 102, the user device 104, or both, via execution of one or more software modules and/or software applications. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the XR server computer 102 determines whether any XR objects 114 are present in the XR environment 112. From operation 202, the method 200 proceeds to operation 204. At operation 204, the XR server computer 102 determines the ownership of each XR object 114. From operation 204, the method 200 proceeds to operation 206. At operation 206, the XR server computer 102 creates an ownership chain 132 for each individual owner (i.e., one of the users 116). From operation 206, the method 200 proceeds to operation 208. At operation 208, the XR server computer 102 assigns the XR objects 114 to the appropriate ownership chain 132. From operation 208, the method 200 proceeds to operation 210. At operation 210, when the XR objects 114 are presented in the XR environment 112, the XR server computer 102 visually differentiates the XR objects 114 based on ownership. For example, XR objects 114 owned by the first user 104A may include a text, color, emphasis, or other visualization that differentiates the XR objects 114 owned by the first user 104A from the XR objects 114 owned by the second user 104B, which may similarly include a text, color, emphasis, or other visualization to differentiate based on ownership.

From operation 210, the method 200 proceeds to operation 212. The method 200 can end at operation 212.

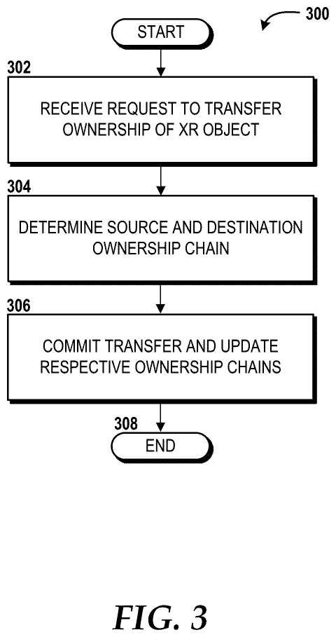

Turning now to FIG. 3, a method 300 for transferring ownership of XR objects 114 will be described, according to an illustrative embodiment. The method 300 begins and proceeds to operation 302. At operation 302, the XR server computer 102 receives a request to transfer ownership of an XR object 114. From operation 302, the method 300 proceeds to operation 304. At operation 304, the XR server computer 102 determines a source ownership chain and a destination ownership chain. From operation 304, the method 300 proceeds to operation 306. At operation 306, the XR server computer 102 commits the transfer and updates the respective ownership chains. From operation 306, the method 300 proceeds to operation 308. The method 300 can end at operation 308.

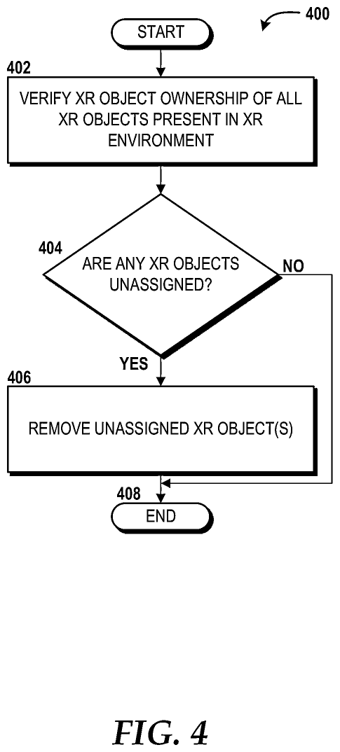

Turning now to FIG. 4, a method 400 for identifying unassigned XR objects 114 within the XR environment 112 will be described, according to an illustrative embodiment. The method 400 begins and proceeds to operation 402. At operation 402, the XR server computer 102 verifies ownership of all XR objects 114 present in the XR environment 112. The XR server computer 102 can verify ownership based upon the XR object ownership data 122.

From operation 402, the method 400 proceeds to operation 404. At operation 404, the XR server computer 102 determines if any XR objects are unassigned. If so, the method 400 proceeds to operation 406. At operation 406, the XR server computer 102 removes the unassigned XR object(s) 134 from the XR environment 112. From operation 406, the method 400 proceeds to operation 408. The method 400 can end at operation 408. If, however, at operation 404, the XR server computer 102 determines that no XR objects are unassigned, the method 400 proceeds to operation 408. The method 400 can end at operation 408.

FIG. 5 is a block diagram illustrating a computer system 500 configured to provide the functionality in accordance with various embodiments of the concepts and technologies disclosed herein. In some implementations, the XR server computer 102 and/or the user devices 104, utilize an architecture that is the same as or similar to the architecture of the computer system 500. It should be understood, however, that modification to the architecture may be made to facilitate certain interactions among elements described herein.

The computer system 500 includes a processing unit 502, a memory 504, one or more user interface devices 506, one or more input/output (“I/O”) devices 508, and one or more network devices 510, each of which is operatively connected to a system bus 512. The bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, a system-on-a-chip, or other type of processor known to those skilled in the art and suitable for controlling the operation of the server computer. Processing units are generally known, and therefore are not described in further detail herein.

The memory 504 communicates with the processing unit 502 via the system bus 512. In some embodiments, the memory 504 is operatively connected to a memory controller (not shown) that enables communication with the processing unit 502 via the system bus 512. The memory 504 includes an operating system 514 and one or more program modules 516. The operating system 514 can include, but is not limited to, members of the WINDOWS, WINDOWS CE, and/or WINDOWS MOBILE families of operating systems from MICROSOFT CORPORATION, the LINUX family of operating systems, the MAC OSX and/or iOS families of operating systems from APPLE CORPORATION, other operating systems, and the like. The operating system 514 can be the XR server OS 108 as illustrated and described with reference to FIG. 1.

The program modules 516 may include various software and/or program modules to perform the various operations described herein. The program modules 516 for the computer system 500 embodied as the XR server computer 102 can include the XR server application 110. The program modules 516 for the computer system 500 embodied as the user device 104 can include the XR app 128. The program modules 516 and/or other programs can be embodied in computer-readable media containing instructions that, when executed by the processing unit 502, perform one or more operations, such as the operations described herein above with reference to the method 400 illustrated in FIG. 4. According to embodiments, the program modules 516 may be embodied in hardware, software, firmware, or any combination thereof.

By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium,” “computer-readable storage medium,” and variations thereof does not include waves or signals per se and/or communication media, and therefore should be construed as being directed to “non-transitory” media only.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer.

The network devices 510 enable the computer system 500 to communicate with other networks or remote systems via a network 518, such as the network(s) 106/600 (best shown in FIGS. 1 and 6). Examples of the network devices 510 include, but are not limited to, a modem, a radio frequency (“RF”) or infrared (“IR”) transceiver, a telephonic interface, a bridge, a router, or a network card. The network 518 may include a wireless network such as, but not limited to, a wireless local area network (“WLAN”), a wireless wide area network (“WWAN”), a wireless personal area network (“WPAN”) such as provided via BLUETOOTH technology, a wireless metropolitan area network (“WMAN”) such as a WiMAX network or metropolitan cellular network. Alternatively, the network 518 may be a wired network such as, but not limited to, a wide area network (“WAN”), a wired LAN such as provided via Ethernet, a wired personal area network n (“PAN”), or a wired metropolitan area network (“MAN”).

Turning now to FIG. 6, additional details of a network 600, such as the network(s) 106, are illustrated, according to an illustrative embodiment. The network 600 includes a cellular network 602, a packet data network 604, for example, the Internet, and a circuit switched network 606, for example, a publicly switched telephone network (“PSTN”). The cellular network 602 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 602 also includes radios and nodes for receiving and transmitting voice, data, and combinations thereof to and from radio transceivers, networks, the packet data network 604, and the circuit switched network 606.

A mobile communications device 608, such as, for example, the user device 104, a cellular telephone, a user equipment, a mobile terminal, a PDA, a laptop computer, a handheld computer, and combinations thereof, can be operatively connected to the cellular network 602. The cellular network 602 can be configured as a 2G Global System for Mobile communications (“GSM”) network and can provide data communications via General Packet Radio Service (“GPRS”) and/or Enhanced Data rates for GSM Evolution (“EDGE”). Additionally, or alternatively, the cellular network 602 can be configured as a 3G Universal Mobile Telecommunications System (“UMTS”) network and can provide data communications via the High-Speed Packet Access (“HSPA”) protocol family, for example, High-Speed Downlink Packet Access (“HSDPA”), Enhanced UpLink (“EUL”) (also referred to as High-Speed Uplink Packet Access (“HSUPA”)), and HSPA+. The cellular network 602 also is compatible with 4G mobile communications standards such as Long-Term Evolution (“LTE”), or the like, as well as evolved and future mobile standards.

The packet data network 604 includes various devices, for example, servers, computers, databases, and other devices in communication with another, as is generally known. The packet data network 604 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (“POTS”). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable devices 610, for example, the user device 104, a PC, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610. In the specification, the network 600 is used to refer broadly to any combination of the networks 602, 604, 606. It should be appreciated that substantially all of the functionality described with reference to the network 600 can be performed by the cellular network 602, the packet data network 604, and/or the circuit switched network 606, alone or in combination with other networks, network elements, and the like.

Turning now to FIG. 7, an illustrative mobile device 700 and components thereof will be described. In some embodiments, the user device 104 described above with reference to FIG. 1A can be configured as and/or can have an architecture similar or identical to the mobile device 700 described herein in FIG. 7. It should be understood, however, that the user device 104 may or may not include the functionality described herein with reference to FIG. 7. While connections are not shown between the various components illustrated in FIG. 7, it should be understood that some, none, or all of the components illustrated in FIG. 7 can be configured to interact with one other to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements, text, images, video, advertisements, prompts, virtual keypads and/or keyboards, messaging data, notification messages, metadata, internet content, device status, time, date, calendar data, device preferences, map and location data, combinations thereof, and the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708 (e.g., the device OS 126), one or more applications 710 (e.g., the XR app 128), other computer-executable instructions stored in a memory 706, or the like. In some embodiments, the applications 710 also can include a UI application (not illustrated in FIG. 7).

The UI application can interface with the operating system 708 to facilitate user interaction with functionality and/or data stored at the mobile device 700 and/or stored elsewhere. In some embodiments, the operating system 708 can include a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, viewing account information, answering/initiating calls, entering/deleting data, entering and setting user IDs and passwords for device access, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700.

According to various embodiments, the applications 710 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interfaced 716 can be configured to support the input/output of data such as location information, user information, organization information, presence status information, user IDs, passwords, and application initiation (start-up) requests. In some embodiments, the I/O interface 716 can include a hardwire connection such as USB port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, the XR component 130, combinations thereof, and the like. It should be appreciated that the I/O interface 716 may be used for communications between the mobile device 700 and a network device or local device.

The mobile device 700 also can include a communications component 717. The communications component 718 can be configured to interface with the processor 704 to facilitate wired and/or wireless communications with one or more networks described above herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMA, CDMAONE, CDMA2000, LTE, and various other 2G, 2.5G, 3G, 4G, 5G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family, including HSDPA, EUL, or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-720N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near-field communications (“NFC”), other radio frequency (“RF”) technologies, combinations thereof, and the like.

In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to a multimedia message service (“MMS”) message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from GPS devices, A-GPS devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, UV, and other wireless media. Combinations of any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 700 or other devices or computers described herein, such as the computer system 500 described above with reference to FIG. 5. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 700 in order to store and execute the software components presented herein. It is also contemplated that the mobile device 700 may not include all of the components shown in FIG. 7, may include other components that are not explicitly shown in FIG. 7, or may utilize an architecture completely different than that shown in FIG. 7.

Based on the foregoing, it should be appreciated that concepts and technologies directed to proof of ownership of XR objects have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. An extended reality server computer comprising:
a processor; and
a memory that stores instructions that, when executed by the processor, cause the processor to perform operations comprising
identifying a plurality of extended reality objects present in an extended reality environment,
determining an owner of an extended reality object of the plurality of extended reality objects, and
visually differentiating, based on the owner, the extended reality object from other extended reality objects of the plurality of extended reality objects.

2. The extended reality server computer of claim 1, wherein the extended reality environment comprises a virtual reality environment, an augmented reality environment, or a mixed reality environment.

3. The extended reality server computer of claim 1, wherein determining the owner of the extended reality object of the plurality of extended reality objects comprises determining, based upon extended reality object ownership data associated with the extended reality object, the owner of the extended reality object of the plurality of extended reality objects.

4. The extended reality server computer of claim 3, wherein the extended reality object ownership data uniquely identifies the owner of the extended reality object based upon an authentication credential.

5. The extended reality server computer of claim 1, wherein the operations further comprise:
creating an ownership chain for the owner; and
assigning the extended reality object and at least one additional extended reality object of the plurality of extended reality objects to the ownership chain.

6. The extended reality server computer of claim 5, wherein the operations further comprise:
receiving a request to transfer ownership of the extended reality object;
determining a source ownership chain and a destination ownership chain; and
committing a transfer of ownership of the extended reality object from the source ownership chain to the destination ownership chain.

7. The extended reality server computer of claim 6, wherein the ownership chain for the owner is the source ownership chain.

8. The extended reality server computer of claim 6, wherein the ownership chain for the owner is the destination ownership chain.

9. A method comprising:
identifying, by an extended reality server computer comprising a processor, a plurality of extended reality objects present in an extended reality environment;
determining, by the extended reality server computer, an owner of an extended reality object of the plurality of extended reality objects; and
visually differentiating, by the extended reality server computer, based on the owner, the extended reality object from other extended reality objects of the plurality of extended reality objects.

10. The method of claim 9, wherein the extended reality environment comprises a virtual reality environment, an augmented reality environment, or a mixed reality environment.

11. The method of claim 9, wherein determining, by the extended reality server computer, the owner of the extended reality object of the plurality of extended reality objects comprises determining, by the extended reality server, based upon extended reality object ownership data associated with the extended reality object, the owner of the extended reality object of the plurality of extended reality objects.

12. The method of claim 11, wherein the extended reality object ownership data uniquely identifies the owner of the extended reality object based upon an authentication credential.

13. The method of claim 9, further comprising:
creating, by the extended reality server computer, an ownership chain for the owner; and
assigning, by the extended reality server computer, the extended reality object and at least one additional extended reality object of the plurality of extended reality objects to the ownership chain.

14. The method of claim 13, further comprising:
receiving, by the extended reality server computer, a request to transfer ownership of the extended reality object;
determining, by the extended reality server computer, a source ownership chain and a destination ownership chain; and
committing, by the extended reality server computer, a transfer of ownership of the extended reality object from the source ownership chain to the destination ownership chain.

15. The method of claim 14, wherein the ownership chain for the owner is the source ownership chain.

16. The method of claim 14, wherein the ownership chain for the owner is the destination ownership chain.

17. The method of claim 9, further comprising:
determining, by the extended reality server computer, whether any of the plurality of extended reality objects are unassigned; and
in response to determining, by the extended reality server computer, that at least one of the plurality of extended reality objects is an unassigned extended reality object, removing, by the extended reality server computer, the unassigned extended reality object from the extended reality environment.

18. A computer-readable storage medium comprising computer-executable instructions that, when executed by a processor of an extended reality server computer, cause the extended reality server computer to perform operations comprising:
identifying a plurality of extended reality objects present in an extended reality environment;
determining an owner of an extended reality object of the plurality of extended reality objects;
creating an ownership chain for the owner; and
assigning the extended reality object and at least one additional extended reality object of the plurality of extended reality objects to the ownership chain.

19. The computer-readable storage medium of claim 18, wherein the operations further comprise:
receiving a request to transfer ownership of the extended reality object;
determining a source ownership chain and a destination ownership chain; and
committing a transfer of ownership of the extended reality object from the source ownership chain to the destination ownership chain.

20. The computer-readable storage medium of claim 18, wherein the operations further comprise:
determining whether any of the plurality of extended reality objects are unassigned; and
in response to determining that at least one of the plurality of extended reality objects is an unassigned extended reality object, removing the unassigned extended reality object from the extended reality environment.
